(19) United States
(12) Patent Application Publication
(10) Pub. No.: US 2025/0337257 A1
(43) Pub. Date: Oct. 30, 2025

(54) Contactor Protection Against Contactor Chattering Under Load

(71) Applicant: Caterpillar Inc., Peoria, IL (US)

(72) Inventors: Avinash P. Dongare, Bengaluru (IN); James K. McCloskey, Barnack, Stamford (GB); Kiran Kamesawara Rajala, Kakinada (IN)

(73) Assignee: Caterpillar Inc., Peoria, IL (US)

(21) Appl. No.: 18/650,434

(22) Filed: Apr. 30, 2024

(51) Int. Cl. H02J 7/00

(52) U.S. Cl. CPC H02J 7/0036; H02J 7/0013; H02J 7/0063

(57) ABSTRACT

A method for controlling at least one contactor associated with at least one battery module, the at least one battery module being switchable between an ON state and an OFF state, the method including: determining whether the at least one battery module is in the ON state; if the at least one battery module is in the ON state, monitoring the at least one contactor for a chattering event; and if the chattering event occurs, at least one of: commanding the at least one battery module to the OFF state, providing an indication to an operator of the at least one battery module, and evaluating whether to place the at least one battery module in lockout.

### TECHNICAL FIELD

The present disclosure generally relates to methods, battery architectures, and controllers to protect against chattering of a contactor of a battery while the battery is under load.

### BACKGROUND

Contactors are the only way to disconnect a battery from a high voltage (“HV”) bus in a controlled way to protect both users of the battery and the battery itself during functional safety violations. Different safety strategies for battery management systems (“BMS”) need to be calibrated carefully to prevent contactor chattering events, which occur when a contactor rapidly fluctuates between open and closed positions despite the contactor being commanded to remain either opened or closed. Such events can occur during testing, when contactors are commanded to frequently open under load. Chattering may damage contactors and present risk to those in vicinity of the battery, and is therefore undesirable.

U.S. Pat. No. 9,434,261 describes detecting whether electrical contactors are welded closed. In that reference, the battery control module determines whether a positive relay and/or pre-charge relay is welded closed. The battery control module may also determine whether a negative relay is welded closed. When one or more of the relays is welded closed, one or more remedial actions may be taken, such as setting a predetermined diagnostic trouble code (“DTC”) in memory, illuminating a malfunction indicator lamp, and/or limiting the vehicle's speed. The reference does not discuss chattering.

### SUMMARY

One aspect of the present disclosure is directed to a method for controlling at least one contactor associated with at least one battery module, the at least one battery module being switchable between an ON state and an OFF state, the method comprising: determining whether the at least one battery module is in the ON state; if the at least one battery module is in the ON state, monitoring the at least one contactor for a chattering event; and if the chattering event occurs, at least one of: commanding the at least one battery module to the OFF state, providing an indication to an operator of the at least one battery module, and evaluating whether to place the at least one battery module in lockout.

Another aspect of the present disclosure is directed to a battery architecture, comprising: at least one battery module switchable between an ON state and an OFF state; at least one contactor associated with at least one battery module; and a controller configured to: determine whether the at least one battery module is in the ON state; if the at least one battery module is in the ON state, monitor the at least one contactor for a chattering event; and if the chattering event occurs, at least one of: command the at least one battery module to the OFF state, provide an indication to an operator of the battery architecture, and evaluate whether to place the at least one battery module in lockout.

A further aspect of the present disclosure is directed to a controller for a battery architecture including at least one battery module switchable between an ON state and an OFF state, the controller being configured to: determine whether the at least one battery module is in the ON state; monitor at least one contactor associated with the at least one battery module for a chattering event; and if the chattering event occurs, at least one of: command the at least one battery module to the OFF state, provide an indication to an operator of the battery architecture, and evaluate whether to place the at least one battery module in lockout.

### BRIEF DESCRIPTION OF THE DRAWINGS

FIG. 1 shows a battery architecture; and

FIG. 2 shows a method according to the present disclosure for controlling a contactor associated with a battery.

### DETAILED DESCRIPTION

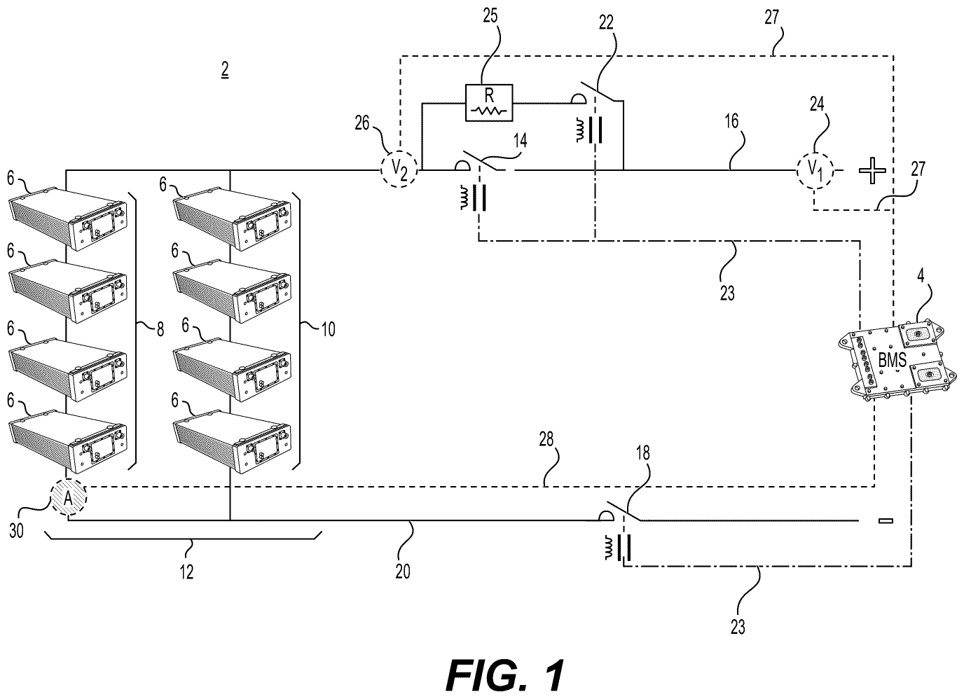

FIG. 1 shows a battery architecture 2. Battery architecture 2 may be used to supply voltage to power one or more loads, such as the drive system of a mobile machine (e.g., construction equipment) and/or the mobile machine's implements. Battery architecture 2 includes a controller or BMS 4 that is operable to control and regulate battery modules 6 of battery architecture 2. In the example shown, two or more battery modules 6 can be connected in series to make a string, such as battery string 8 or battery string 10, each of which includes four battery modules 6. Furthermore, two or more battery strings, such as battery string 8 and battery string 10, can be connected in parallel to create a battery pack, such as battery pack 12.

A battery module 6 can be switched between an ON state and OFF state. For example, if battery architecture 2, which includes at least one battery module 6, is used in a mobile machine, an ignition key to that mobile machine can be switched between an ON state and OFF state. When the key is switched to the ON state, battery architecture 2 can provide voltage to power one or more loads associated with the mobile machine (e.g., to the drive system of a mobile machine). Specifically, turning the key to the ON state may close one or more contactors associated with the at least one battery module 6 of battery architecture 2 so that the at least one battery module 6 can supply voltage, bringing the at least one battery module 6 online. Battery module 6 can also be placed in the OFF state, or taken offline, by opening the one or more contactors associated with the at least one battery module 6. Specifically, battery module 6 can be placed in the OFF state by switching the key of the mobile machine to the OFF state, which in turn opens the one or more contactors associated with battery module 6.

The concept of switching between an ON state and OFF state is also applicable to a battery string, such as battery strings 8 and 10, as well as to a battery pack, such as battery pack 12, that includes one or more battery strings. Specifically, if battery architecture 2 must provide a greater voltage to power a larger load associated with a mobile machine, it may be desirable for battery architecture 2 to include a plurality of battery modules 6 arranged in one or more battery strings, such as battery strings 8 and 10. When the voltage provided by such a battery architecture 2 is not needed (e.g., when the mobile machine housing battery architecture 2 is not being operated), the operator of the mobile machine can switch the key of the mobile machine to an OFF state, which in turn places battery architecture 2 and its battery modules 6 in an OFF state. In this sense, the term “battery” may refer to an individual battery module 6, a battery string 8 or 10, a battery pack 12, or a battery architecture 2.

In this example, battery architecture 2 has a positive contactor 14 on voltage bus 16 and a negative contactor 18 on ground 20. Each of these contactors is associated with battery architecture 2 and its battery modules 6 in the sense that the contactors have the ability to connect and disconnect portions of the circuit provided by battery architecture 2. Voltage bus 16 may be an HV bus. Battery architecture 2 may also include one or more additional contactors, such as pre-charge contactor 22, which includes a pre-charge resistor 25. Controller 4, in turn can be connected to each of positive contactor 14, negative contactor 18, and pre-charge contactor 22 to monitor and control their status (i.e., whether the contactor is open or closed), through analog feedback lines 23. Controller 4 can also be connected to one or more voltage sensors within battery architecture 2, such as first voltage sensor 24 that senses the voltage on voltage bus 16 downstream of positive contactor 14, and second voltage sensor 26 that senses the voltage on voltage bus 16 upstream of positive contactor 14 (i.e., the voltage produced by battery pack 12). Connections between controller 4 and first voltage sensor 24 and second voltage sensor 26 can be sensor lines 27. Controller 4 may also be connected via a controller area network (“CAN”) datalink 28 to one or more sensors 30 on ground 20 or elsewhere within battery architecture 2.

In the context of battery architecture 2, a chattering event will occur if any one of positive contactor 14, negative contactor 18, and pre-charge contactor 22 fluctuates between open and closed positions despite the contactor being commanded to remain opened or closed. There is a need to avoid such chattering events, as persistent chatter may cause the contacts of a contactor to become welded or fixed to one another, rendering the contactor unusable. There is also a need to notify an operator of a mobile machine including battery architecture 2 of the occurrence of the chattering event so as to improve safety.

The present application describes methods, battery architectures, and controllers that facilitate detection of a chattering event of a contactor associated with a battery, which battery could be, for example, a battery module 6, a battery string 8 or 10, a battery pack 12, or a battery architecture 2. A chattering event can occur if a number of open/close occurrences of a contactor exceeds a count threshold within a predefined amount of time, despite the contactor being commanded to remain opened or closed. For example, a controller or BMS 4 associated with battery architecture 2 could determine that a chattering event has occurred if positive contactor 14 undergoes five open/close occurrences in five seconds or less. Other numbers of open/close occurrences and predefined amounts of time are possible and within the scope of the present application. Moreover, the discussion herein is applicable to any contactor of a battery architecture 2, including positive contactor 14, negative contactor 18, pre-charge contactor 22, and/or any other contactor.

Other conditions could also be used to determine whether a chattering event occurs. For example, controller 4 may determine that a chattering event has occurred only if a key, such as an ignition key of a mobile machine, associated with battery architecture 2 is in an ON state. When such a key is in the ON state, battery architecture 2 may then be capable of providing voltage to power one or more loads associated with battery architecture 2 (e.g., by closing one or more contactors within battery architecture 2). Controller 4 may also determine that a chattering event has occurred if a bus current flowing through a voltage bus associated with the at least one battery module 6, such as voltage bus 16 in FIG. 1, is greater than a bus current threshold. The bus current threshold could be, for example, five amps during both charging and discharging. Other bus current threshold values are possible and within the scope of the present application.

In response to a chattering event, the methods, battery architectures, and controllers of the present application can implement various courses of action. For example, at least one battery module 6 of battery architecture 2 could be commanded to be offline, or put in an OFF state, in which the associated contactor is opened. The methods, battery architectures, and controllers of the present application could also provide an indication to an operator of battery architecture 2 if a chattering event occurs. One example of an indication is an issuance of a fault code or a diagnostic trouble code (“DTC”).

If a chattering event is detected, the methods, battery architectures, and controllers of the present application can allow several retry attempts to bring the at least one battery module 6 back online, or into the ON state, in which the associated contactor is closed. A retry attempt can occur in various scenarios. In one scenario, it is determined whether the key associated with battery architecture 2 has been cycled. A key cycle can include switching the key from the ON state to the OFF state, then back to the ON state. Alternatively, or in addition, a retry attempt can occur after a specified duration of time (e.g., ten seconds) has passed.

If a chattering event is still detected after a defined number of retry attempts (e.g., three retry attempts), the at least one battery module 6 will enter lockout, during which the at least one battery module 6 will not be allowed to operate (i.e., provide voltage to power a load) until an operator of battery architecture 2 or a technician diagnoses the issue. If the defined number of retry attempts is exceeded, the methods, battery architectures, and controllers of the present application can also issue a subsequent indication, such as another fault code or DTC.

In this manner, the methods, battery architectures, and controllers of the present application both protect one or more contactors from becoming fixed in a closed position (i.e., welded), and provide one or more indications to an operator of the at least one battery module 6 and/or battery architecture 2 that the at least one battery module 6 is not functioning properly. The operator and/or a technician can then troubleshoot the at least one battery module 6 as appropriate. As such, the methods, battery architectures, and controllers of the present application improve the safety of a BMS, particularly when the BMS uses one or more contactors with an HV bus, by helping to avoid contact chattering under load and providing an indication or alert when a chattering event occurs. Other advantages are also possible, as contemplated herein, such as avoiding contactor chattering under load and protecting individuals who may come into contact with the at least one battery module 6 and its associated contactor.

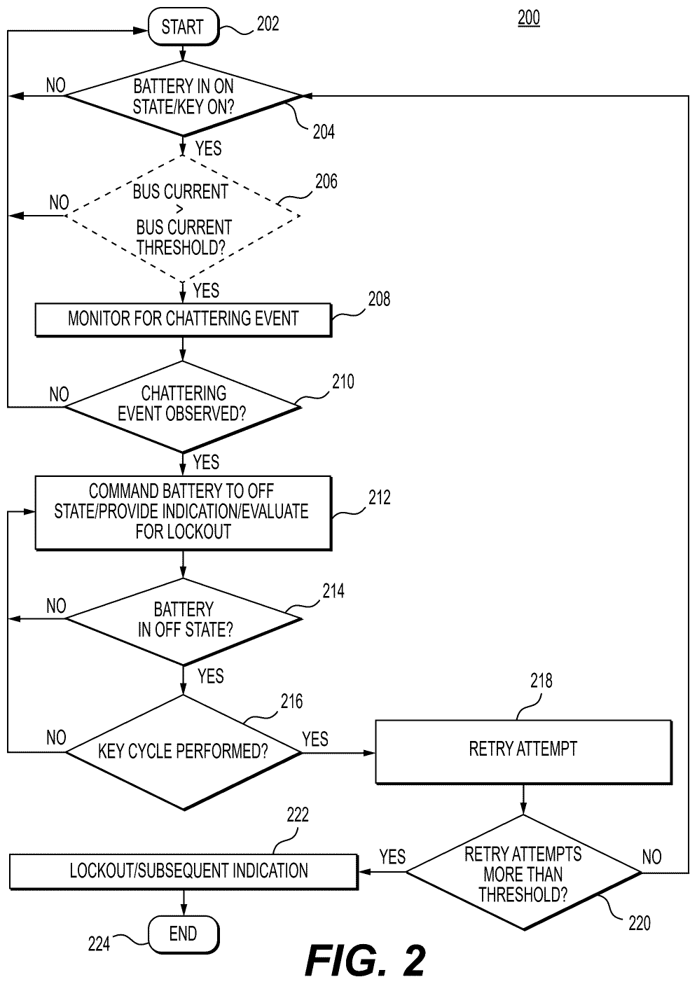

The methods, battery architectures, and controllers of the present application will now be discussed in the context of FIG. 2, which shows a method 200 for controlling at least one contactor (e.g., positive contactor 14, negative contactor 18, pre-charge contactor 22, and/or another contactor) associated with a battery, such as battery module 6, the battery being switchable between an ON state and an OFF state.

As shown in FIG. 2, method 200 starts at block 202. At step 204, it is determined whether the battery 6 (e.g., of a battery architecture 2) is in the ON state. This determination can be performed by, for example, controller 4. The battery is in the ON state when at least one contactor associated with the battery is closed. As a proxy for determining whether the battery is in the ON state, step 204 can consider whether a key associated with battery architecture 2 is in the ON state. If the battery is in the ON state and/or the key is in the ON state, method 200 proceeds to the next step. If the battery is not in the ON state and/or the key is not in the ON state, method 200 returns to block 202, and method 200 begins again.

Step 206 of method 200 is optional. In step 206, method 200 determines whether a bus current flowing through a voltage bus associated with the battery (e.g., voltage bus 16) is greater than a bus current threshold (e.g., five amps). If the bus current exceeds the bus current threshold, method 200 proceeds to the next step. If the bus current does not exceed the bus current threshold, method 200 returns to block 202, and method 200 begins again.

In step 208, method 200 monitors at least one contactor (e.g., positive contactor 14, negative contactor 18, pre-charge contactor 22, and/or another contactor) associated with the battery for a chattering event. As discussed, a chattering event can occur if a number of open/close occurrences of the at least one contactor exceeds a count threshold within a predefined amount of time.

In step 210, method 200 determines whether a chattering event has been observed. If not, method 200 returns to block 202, and method 200 begins again. However, if a chattering event is observed, method 200 proceeds to step 212, and at least one of: commands the battery to the OFF state; provides an indication to an operator of the battery; and evaluates whether to place the battery in lockout, as discussed in more detail herein.

In step 214, method 200 determines whether the battery is in the OFF state. This step is implemented because even though the battery may have been previously commanded to be in the OFF state, a contactor associated with the battery may be stuck in the closed position, or welded, as a result of the chattering event. If in step 214 it is determined that the battery is not in the OFF state, method 200 reverts to step 212. If, however, in step 214 it is determined that the battery is in the OFF state, method 200 can proceed to the next step.

In step 216, method 200 determines whether a key cycle of the key associated with the battery has been performed. As discussed, a key cycle can involve switching the key from the ON state to the OFF state, then back to the ON state. If in step 216 a key cycle has not been performed, method 200 reverts to step 212. If, however, in step 214 it is determined that a key cycle has been performed, method 200 can proceed to the next step.

In step 218, method 200 initiates a retry attempt, which involves instructing (e.g., by controller 4) the battery to revert to the ON state. Before the retry attempt is carried out, however, in step 220 method 200 evaluates whether the current number of retry attempts is more than a retry attempt threshold (e.g., three retry attempts). If the number of retry attempts is more than the retry attempt threshold, method 200 proceeds to step 222. In that step, method 200 could involve a lockout of the battery, which prevents the battery from operating until the battery and/or its contactor is evaluated, and/or issuing a subsequent indication, such as another fault code or a DTC. If, however, in step 220 the number of retry attempts is not more than the retry attempt threshold, method 200 proceeds to step 204, and operation continues as previously discussed (i.e., by monitoring for a subsequent chattering event).

Other variations of the preceding steps are also possible and within the scope of the present application. For example, various steps could be omitted and/or reordered without departing from the scope of the present application.

### INDUSTRIAL APPLICABILITY

In general, the methods, battery architectures, and controllers of the present application are applicable for avoiding contactor chattering under load and protecting individuals who may come into contact with a battery and its associated contactor. In response to detecting a chattering event, the methods, battery architectures, and controllers described herein can take various courses of action, including taking the battery offline, providing one or more indications to an operator of the battery, and evaluating whether to place the battery in lockout. Placing the battery in lockout renders the battery inoperable until it can be assessed by a technician. As such, the methods, battery architectures, and controllers of the present application improve the safety of a BMS, particularly when the BMS uses one or more contactors with an HV bus, by helping to avoid contact chattering under load and providing an indication or alert when a chattering event occurs.

What is claimed is:

1. A method for controlling at least one contactor associated with at least one battery module, the at least one battery module being switchable between an ON state and an OFF state, the method comprising:
determining whether the at least one battery module is in the ON state;
if the at least one battery module is in the ON state, monitoring the at least one contactor for a chattering event; and
if the chattering event occurs, at least one of:
commanding the at least one battery module to the OFF state,
providing an indication to an operator of the at least one battery module, and
evaluating whether to place the at least one battery module in lockout.

2. The method of claim 1, wherein the chattering event occurs if a number of open/close occurrences of the at least one contactor exceeds a count threshold within a predefined amount of time.

3. The method of claim 1, wherein, if the at least one battery module is commanded to the OFF state, the method further comprises:
determining whether the at least one battery module is in the OFF state.

4. The method of claim 3, wherein the at least one battery module is determined to be in the ON state if a key associated with the at least one battery module is determined to be in an ON state.

5. The method of claim 4, wherein, if the at least one battery module is in the OFF state, the method further comprises:
determining whether a key cycle of the key has been performed, the key cycle comprising switching the key from the ON state to the OFF state, then back to the ON state.

6. The method of claim 5, wherein, if the key cycle has been performed, the method further comprises:
commanding the at least one battery module to the ON state as a retry attempt.

7. The method of claim 6, further comprising:
if a number of retry attempts exceeds a retry attempt threshold, at least one of:
placing the at least one battery module in lockout, and
providing a subsequent indication to the operator of the at least one battery module.

8. The method of claim 6, further comprising:
if a number of retry attempts does not exceed a retry attempt threshold, determining whether the at least one battery module is in the ON state; and
monitoring the at least one contactor for a subsequent chattering event.

9. The method of claim 1, further comprising:
if the at least one battery module is in the ON state, determining whether a bus current flowing through a voltage bus associated with the at least one battery module is greater than a bus current threshold; and
monitoring the at least one contactor for the chattering event only if the bus current is greater than the bus current threshold.

10. The method of claim 2, wherein the number of open/close occurrences is five or more and the predefined amount of time is five seconds or less.

11. The method of claim 1, wherein the at least one battery module comprises a plurality of battery modules connected in series so as to form a battery string.

12. The method of claim 1, wherein the at least one battery module comprises a first plurality of battery modules connected in series so as to form a first battery string, and a second plurality of battery modules connected in series so as to form a second battery string, and
wherein the first battery string and the second battery string are connected in parallel so as to form a battery pack.

13. A battery architecture, comprising:
at least one battery module switchable between an ON state and an OFF state;
at least one contactor associated with at least one battery module; and
a controller configured to:
determine whether the at least one battery module is in the ON state;
if the at least one battery module is in the ON state, monitor the at least one contactor for a chattering event; and
if the chattering event occurs, at least one of:
command the at least one battery module to the OFF state,
provide an indication to an operator of the battery architecture, and
evaluate whether to place the at least one battery module in lockout.

14. The battery architecture of claim 13, wherein the chattering event occurs if a number of open/close occurrences of the at least one contactor exceeds a count threshold within a predefined amount of time.

15. The battery architecture of claim 13, wherein if the at least one battery module is in the ON state, the controller is configured to:
determine whether a bus current flowing through a voltage bus associated with the at least one battery module is greater than a bus current threshold; and
monitor the at least one contactor for the chattering event only if the bus current is greater than the bus current threshold.

16. The battery architecture of claim 13, wherein the at least one battery module comprises a plurality of battery modules connected in series so as to form a battery string.

17. The battery architecture of claim 13, wherein the at least one battery module comprises a first plurality of battery modules connected in series so as to form a first battery string, and a second plurality of battery modules connected in series so as to form a second battery string, and
wherein the first battery string and the second battery string are connected in parallel so as to form a battery pack.

18. A controller for a battery architecture including at least one battery module switchable between an ON state and an OFF state, the controller being configured to:
determine whether the at least one battery module is in the ON state;
monitor at least one contactor associated with the at least one battery module for a chattering event; and
if the chattering event occurs, at least one of:
command the at least one battery module to the OFF state,
provide an indication to an operator of the battery architecture, and
evaluate whether to place the at least one battery module in lockout.

19. The controller of claim 18, wherein the chattering event occurs if a number of open/close occurrences of the at least one contactor exceeds a count threshold within a predefined amount of time.

20. The controller of claim 18, wherein the at least one battery module comprises a plurality of battery modules connected in series so as to form a battery string.
